(19) United States
(12) Patent Application Publication
(10) Pub. No.: US 2017/0110751 A1
(43) Pub. Date: Apr. 20, 2017

(54) CARBON FUEL CELLS

(71) Applicants: Roy Edward MCALISTER, Chandler, AZ (US); ADVANCED GREEN TECHNOLOGIES, LLC, Chandler, AZ (US)

(72) Inventor: Roy Edward McAlister, Phoenix, AZ (US)

(21) Appl. No.: 15/314,919

(22) PCT Filed: May 29, 2015
(86) PCT No.: PCT/US2015/033349

§ 371 Date: Nov. 29, 2016

Related U.S. Application Data
(60) Provisional application No. 62/004,791, filed on May 29, 2014.

(51) Int. Cl. H01M 8/1233; F02M 27/04; F02M 27/02; H01M 8/0612; C01B 3/24

(52) U.S. Cl. CPC H01M 8/1233; H01M 8/0618; H01M 8/0643; C01B 3/24; C01B 31/18; C01B 31/20; F02M 27/02; F02M 27/04; C01B 2203/0272; C01B 2203/066; C01B 2203/1235; C01B 2203/84

(57) ABSTRACT

In one aspect, a system for converting a feedstock into a specialized carbon fuel for energy conversion includes a re actor to receive a feedstock substance and dissociate the feedstock substance to carbon constituents and hydrogen by applying one or both of heat and electric current, the carbon constituents including hot carbon having a temperature state in a range of 700° C. to 1500° C. and having an increased chemical potential energy capable of storing external energy; and a fuel cell structured to include a chamber to receive the hot carbon, the fuel cell operable to receive and use the hot carbon as a fuel and air as an oxidant to (i) produce one or more oxides of carbon and one or more nitrogenous substances, or (ii) extract electrical energy from the hot carbon.

### TECHNICAL FIELD

This patent document relates to systems, devices, and processes that use fuel cell technologies.

### BACKGROUND

A fuel cell includes a type of device that can convert chemical energy from a substance (e.g., referred to as a fuel) into electrical energy (e.g., electricity). Generally, the energy conversion includes a chemical reaction with oxygen or another oxidizing agent. For example, hydrogen is among a common fuel, and hydrocarbons such as natural gas and alcohols can also be used in fuel cells. For example, fuel cells differ from batteries in that they require a constant source of fuel and oxygen to operate, but can produce electricity continually provided the fuel and oxygen inputs are supplied to the fuel cell.

### BRIEF DESCRIPTION OF THE DRAWINGS

FIG. 1A shows a process diagram of an exemplary method for converting a feedstock fuel into products including hot carbon capable of being used for producing electrical energy in a fuel cell.

FIG. 1B shows a diagram of an exemplary system for converting a feedstock fuel into products including hot carbon capable of being used for producing electrical energy in a fuel cell.

FIG. 2A shows a schematic diagram of an exemplary carbon fuel cell device of the disclosed technology.

FIGS. 2B and 2C show enlarged views of portions of the exemplary carbon fuel cell device of FIG. 2A.

FIG. 2D shows a schematic diagram of an exemplary engine assembly including the exemplary carbon fuel cell device of FIG. 2A.

### DETAILED DESCRIPTION

Techniques, systems, and devices are disclosed for implementing carbon fuel cells using hot carbon and/or hydrogen.

In some aspects, a method to convert such a feedstock substance (e.g., a fossil fuel or renewable fuel) into energy and specialized fuel substances includes dissociating a fuel to produce hot carbon and hydrogen, e.g., in a reactor. Hot carbon includes carbon material at an elevated temperature state, e.g., in a range of 700° C. to 1500° C., and/or at an elevated temperature approaching visible light emitting or incandescent temperatures. The produced hot carbon is of a material form having an increased chemical and/or thermal potential energy and is capable of storing energy from an external source (e.g., heat). The hot carbon can be produced by endothermic dissociation of a carbon and/or hydrogen donor substance (e.g., CₓH_{y}), in which the dissociating includes providing heat and/or electric current (e.g., electrons) to produce the carbon and the hydrogen. The method includes removing the produced hydrogen and hot carbon from the reactor, e.g., by depositing the hot carbon in a chamber. In some implementations, the method further includes supplying an oxygen- and/or hydrogen-containing reactant (e.g., such as oxygen, steam, alcohol, or air) to contact the hot carbon to exothermically produce products such as carbon monoxide (CO) and hydrogen (H2), in which, after the supplying the reactant, remaining deposited carbon forms a durable carbon-based good or product. In some implementations of the method, the method further includes utilizing the produced hot carbon as a fuel in a carbon fuel cell of the disclosed technology. The carbon fuel cell can use air as an oxidant and produce, using the hot carbon as fuel, carbon oxide products (e.g., CO and/or CO₂) and nitrogenous products, e.g., in which nitrogen-rich feedstock can be separated in the carbon fuel cell for making ammonia (NH₃) and other nitrogenous substances, e.g., such as urea (CH₄N₂O).

In some implementations of the method, for example, in the reactor, one or more electrodes are electrified with the electrical energy that provide electrons and/or generate heat to dissociate the fuel (e.g., CH₄) into carbon and hydrogen. For example, the dissociating can include endothermic conversion of the fuel (e.g., CₓH_{y}) to the hot carbon (xC) and hydrogen (H₂), where CₓH_{y}+Energy (e.g., thermal and/or electrical energy at the electrodes that generate heat)→xC+0.5y H₂ can occur at or near the electrode(s). For example, the electrode(s) can be configured as a suitable metallic alloy, graphite, silicon carbide or molybdenum disilicide electrode, and/or a composite electrode assembly described later in this patent document. In some implementations, for example, the produced hydrogen can be fed to a pressurizer (e.g., galvanic cell with a proton membrane) that pressurizes the hydrogen for use, for example, in a carbon fuel cell of the disclosed technology. In some examples, ship vessels could use electricity from their electrical generators or from ports to power this dissociation step.

In implementations of the method, for example, the carbon can be removed from the fuel by an endothermic precipitation process. For example, the deposited hot carbon can be used to store energy from regenerative processes, e.g., such as regenerative braking or shock absorbers in vehicle applications. Furthermore, electricity from regenerative processes can be used to drive the dissociating (e.g., in the reactor of the system to implement the method). In some implementations, for example, hot carbon is deposited in the chamber on a substrate, and/or in which the chamber is electrically and/or thermally insulated. Exemplary substrates can include, but are not limited to, graphene, nickel, mica, silicon carbide, ceramic, or carbon with a SiN and/or BN coating, among others.

For example, the deposited or banked hot carbon can be formed as amorphous carbon (e.g., hot carbon depositions) in the chamber, which provides dense thermal storage capability. In the chamber, for example, the hot banked carbon can be formed on a suitable surface, e.g., such as a scored glass ceramic or vitreous carbon. The hot banked carbon can be readily utilized in the chamber and/or continuously or intermittently (e.g., at desired occasions) removed to a suitable location to provide thermal and chemical banking of external energy or substances, respectively. For example, thermal or electrical energy banking to the hot banked carbon can provide better energy storage efficiency than a battery, as well as be substantially more inexpensive (e.g., without need for additional and costly materials). For example, energy conversion cycle efficiency of the created hot banked carbon can be ˜50%, as compared to that of battery of less than 12%.

In some implementations, the fuel-to-energy conversion method can be implemented to additionally, or alternatively, create hot banked nitrogen as a material for banking energy and providing capability to produce subsequent products. For example, nitrogen can be taken from the air or from nitrogen rich exhaust and combined with hydrogen to make ammonia or urea. In such implementations, the banking comes from the formation of a compound (e.g., ammonia or urea). For example, pressurized hydrogen and nitrogen are used to form ammonia and/or urea.

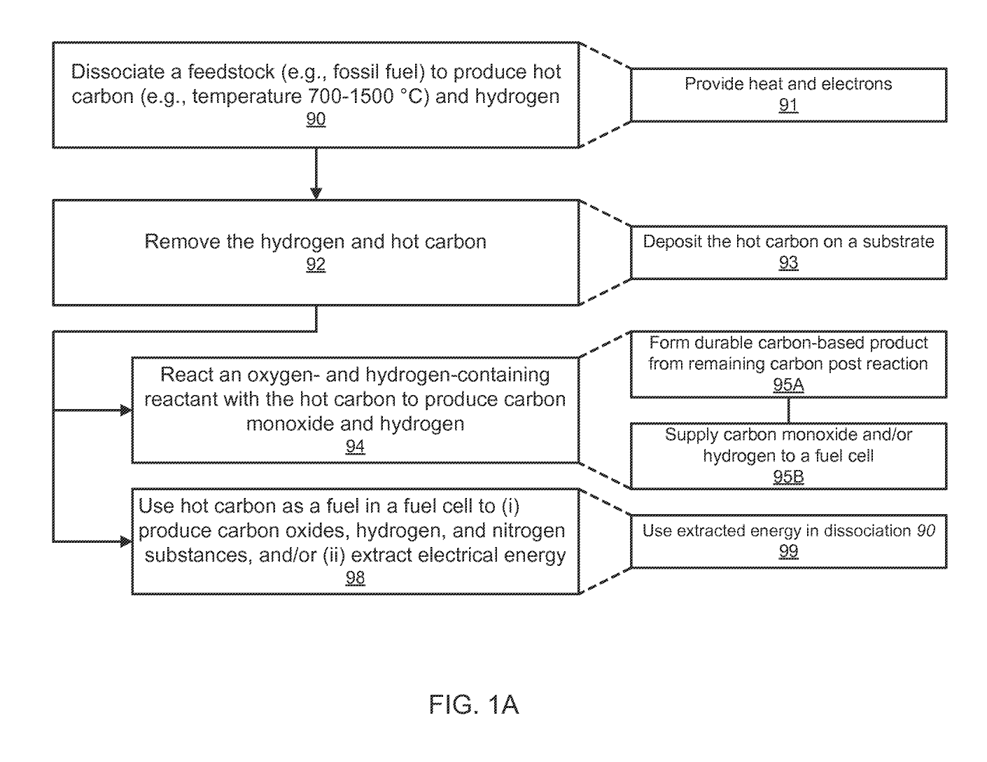

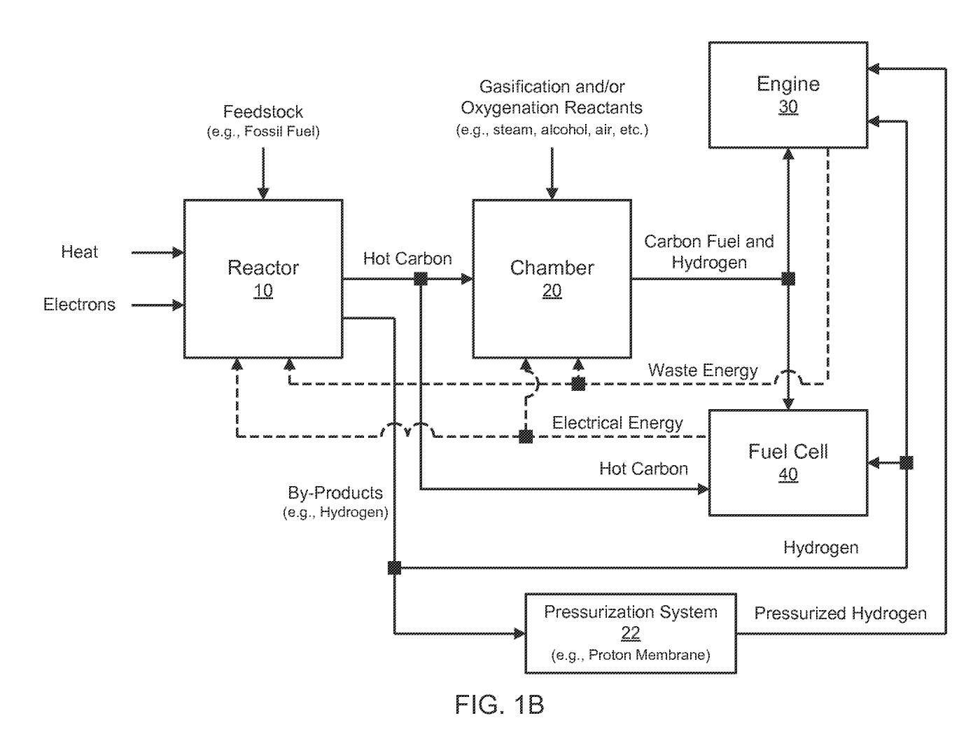

FIG. 1A shows a process diagram of an exemplary method for converting a feedstock, e.g., such as a fossil fuel, into specialized products including hot carbon used for storing energy and/or creating renewable fuels. The method can include a process 90 to dissociate the feedstock to produce hot carbon (e.g., having a temperature of 700° C. to 1500°) and hydrogen, e.g., which can be implemented in a reactor. In some implementations of the process 90, the dissociating can include a process 91 to provide heat and/or electrons to produce the hot carbon from the dissociated products of the feedstock. The method can include a process 92 to remove the hot carbon and the hydrogen. In some implementations of the process 92 can include a process 93 to deposit the hot carbon on a substrate or surface, e.g., in a chamber (e.g., including an accumulator).

The method shown in FIG. 1A can further include a process 94 to react an oxygen- and hydrogen-containing reactant with the hot carbon to produce an oxide of carbon (e.g., carbon monoxide) and hydrogen. In some implementations of the process 94, the reacting can include a process 95A to form a durable carbon-based product from the remaining carbon after implementation of the process 94; and/or, the reacting can include a process 958 to supply the produced carbon monoxide and/or the produced hydrogen to an engine and/or to a fuel cell.

The method shown in FIG. 1A can further include a process 98 to use the hot carbon in a fuel cell to (i) produce carbon oxide(s), hydrogen, and/or nitrogen substances, and/or to (ii) extract electrical energy from the hot carbon, which can be used in other processes of the method. In some implementations of the process 98, the electrical energy extracted by the hot carbon can be used in the process 90 to dissociate the feedstock.

FIG. 1B shows a diagram of a system capable of implementing the method of FIG. 1A for converting a feedstock into specialized products including hot carbon and by-products including hydrogen for use in a fuel cell. In one exemplary embodiment, the system includes a reactor 10 to receive the feedstock substance (e.g., a carbon- and/or hydrogen-donor substance such as a fossil fuel or renewable fuel including methane) and dissociate the feedstock substance to carbon constituents and hydrogen. The reactor 10 is used to produce hot carbon by applying heat and/or electrons during the dissociation of the feedstock, such that the hot carbon produced is a specialized form of carbon having an increased chemical potential energy and is capable of storing external energy when applied to the hot carbon. The system includes a chamber 20 where the hot carbon can be deposited. In some embodiments, for example, the chamber 20 is electrically and/or thermally insulated and includes a substrate to deposit the hot carbon. For example, the substrate can include, but is not limited to, graphene, nickel, mica, silicon carbide, molybdenum disilicide, ceramic, or carbon with a SiN and/or BN coating, among other materials.

The system can further include a carbon fuel cell 40 to receive and utilize the produced carbon-containing fuel and/or the produced hydrogen as the fuel or other reactants in the carbon fuel cell 40 to extract electrical energy. Such electrical energy, as well as electrical charge carriers (e.g., electrons) may be included in the system and supplied to the chamber 20 and/or the reactor 10 to assist in reactions (e.g., such as the dissociation of the feedstock in the reactor 10 to produce the hot carbon banked in the chamber 20). Additionally, for example, the hydrogen produced by the reactor 10 can also be supplied to the carbon fuel cell 40 for use in fuel cell reactions. Furthermore, for example, the hydrogen produced by the reactor 10 can also be pressurized by the pressurization system 22 to supply pressurized hydrogen to the carbon fuel cell 40.

In some implementations of the system, the deposited hot carbon in the chamber 20 can be reacted with gasification and/or oxygenation reactants (e.g., such as steam, alcohol, air, etc.) to produce a carbon-containing fuel and hydrogen. In such implementations, for example, the system can further include an engine 30 to receive and utilize the produced carbon-containing fuel and/or the produced hydrogen as fuel or other reactants in reactions within the engine 30 (e.g., including combustion). Additionally, for example, the hydrogen produced by the reactor 10 can also be supplied to the engine 30 in such reactions (e.g., combustion). Moreover, for example, the hydrogen produced by the reactor 10 can be pressurized by a pressurization system 22 to supply pressurized hydrogen to the engine 30. The engine 30 may produce waste heat as part of reactions implemented in the engine 30. Such waste heat may be included in the system and supplied to the chamber 20 and/or the reactor 10 to assist in reactions (e.g., such as the dissociation of the feedstock in the reactor 10 to produce the hot carbon banked in the chamber 20).

### EXEMPLARY EMBODIMENTS

Further embodiments of the fuel cells shown in FIG. 1A that can implement the methods shown in FIG. 1B are described in the following examples.

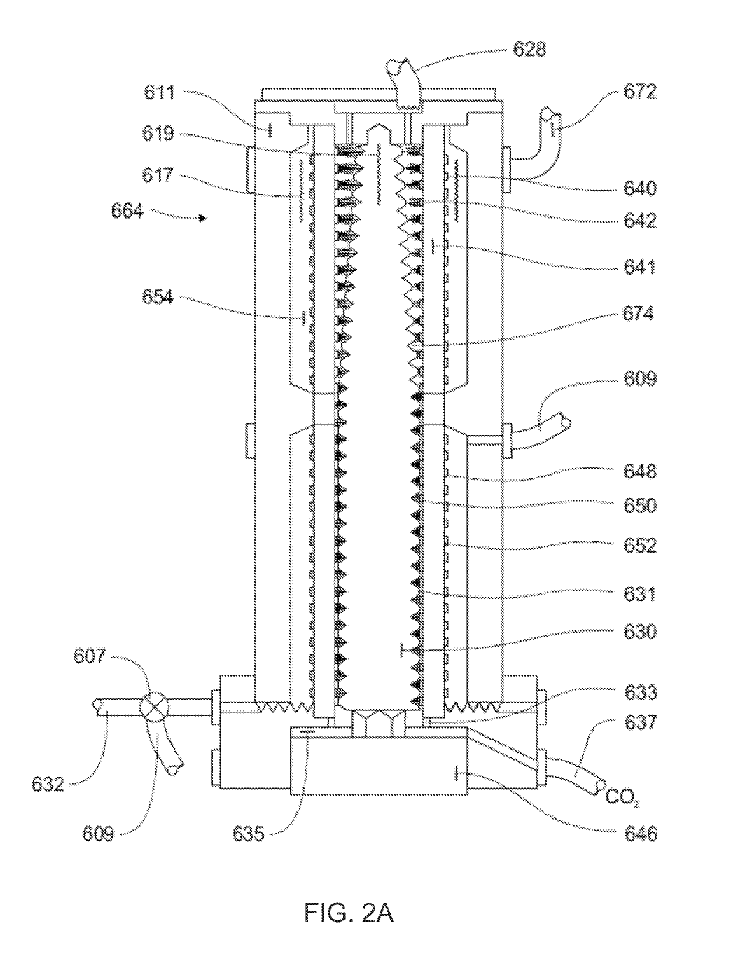

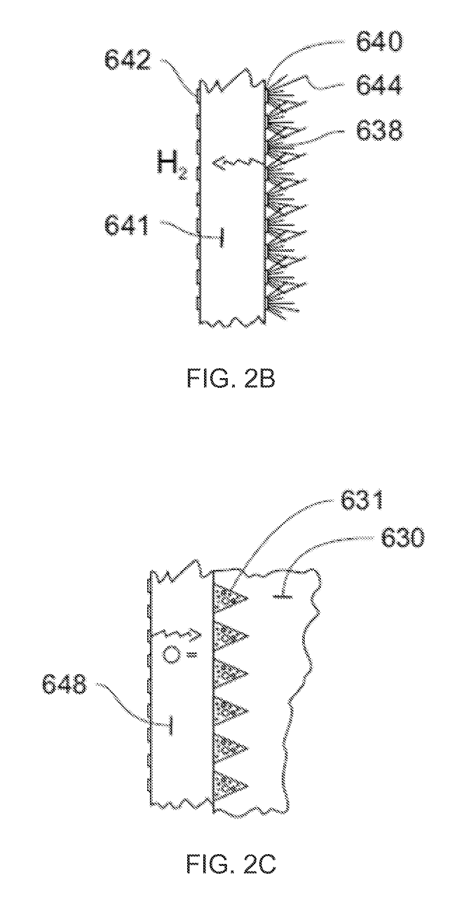

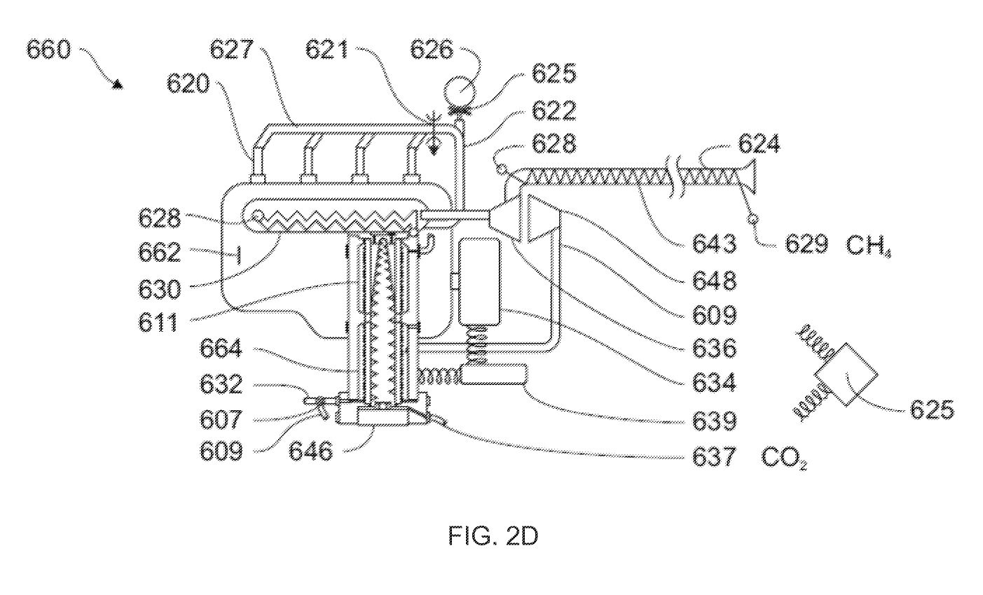

FIG. 2D shows a schematic diagram of a system 660 including an exemplary hydrogen combustion engine 662 and the exemplary carbon fuel cell device 664 operable to produce heat and electricity and/or propulsive power at greater overall efficiencies than conventional systems. Direct current produced by the carbon fuel cell 664 can be supplied to an inverter 639 of the system 660 along with electricity from an engine-driven generator of the system 660, e.g., such as alternator 634 shown in FIG. 2D, to produce a combined cycle to meet peak power along with lower demands such as at night and other times when the fuel cell can operate on hot carbon to quietly produce power. In implementations, for example, fuel such as a suitable nitrogenous compound {NₓC_{y}H_{z}}, fuel alcohol {CₙH₍₂ₙ₊₁₎OH}, or a hydrocarbon {CₓH_{y}} can be preheated by heat transfers from engine coolant (H1), and/or the exhaust gases (H2) from renewable sources including regenerative operations (H3) and/or the engine 662 or the engine-driven generator 634 (H3) including electric resistance or inductive heating. In this and other embodiments, such heat transfers are made according to source and receiver temperature differences and in amounts sufficient to accomplish the indicated purposes.

Selected components of the system 660 are shown in a simplified circuit for preheating fuel supplied through connection 629 to countercurrent heat exchanger 624 in insulated exhaust pipe 630-643 to insulated exhaust manifold heat exchange conduit 628 to substantially achieve the endothermic process summarized by Equations 1 and 2. Additional heat is supplied by resistive and/or inductive heating to deposit carbon and separate hydrogen in reactor 640-641-642.

Equation 1 shows production of hydrogen and carbon (e.g., which can be produced as hot carbon) from virtually any carbon donor fuel C_{y}H_{z}.

C_{y}H_{z}+Heat₁→yC+0.5z H₂ Equation 1

Equation 2 shows production of the carbon and hydrogen from CH₄ hydrocarbon fuel selections, e.g., such as natural gas or renewable methane.

CH₄+Heat₂→C+2H₂ Equation 2

Endothermic Heat₂ required for the process of Equation 2 is about 75 KJ/mol or less depending upon the amount of regenerative preheat and the temperature of an electrode in the reactor. In this mode, the carbon is deposited or “hot banked” in a chamber, e.g., including in a carbon fuel cell device of the disclosed technology.

As shown in FIGS. 2A, 2B and 2C preheated fuel such as methane delivered by conduit 628 is dissociated on suitably sited catalysts 638 presented at the surface of catalytic nucleation sites on tubular proton exchange membrane 641 to produce carbon such as amorphous, dendrites, fuzz, feather-like or otherwise highly faulted or disorganized carbon along with separated hydrogen ions that are transported through membrane 641 across an electrical field between inner electrode 642 toward outer electrode 640. Heat additions in reactor 640-641-642 include resistive and/or inductive heating of electrodes 640-642 and/or membrane 641 along with resistive and/or inductive heating by elements 617 of suitable length and power rating or similar elements 619 within or around conveyer 630 in the annular space region. Thus, reactor portion of assembly 664 produces galvanically pressurized hydrogen for operation of engine 602 and/or a hydrogen fuel cell along with separated carbon that is delivered to fuel cell 650-648-652 by rotary conveyer 630.

Galvanic pressurization of hydrogen is adaptively varied to optimize oxidant-utilization efficiency in the combustion chambers of engine 662. Such adaptive optimization and control include further pressure modulation and regulation by rapid adjustments by regulator 621 and similar provisions within each injector 620 along with adaptive duration of flow times and timing between successive injections and/or other injection pattern modifications as disclosed herein and by reference regarding control operations.

Porous, permeable, or helical electrode 640 and catalysts 638 produce amorphous or highly faulted or disorganized carbon growths or deposits 644 as galvanically pressurized hot hydrogen is delivered through insulated conduit 622 to injectors 620 for direct hydrogen injection before, at, or after TDC for operation of engine 662. Carbon deposits 644 are ultrasonically and/or mechanically swept or dislodged from the locations of deposition and removed by rotary conveyer 630, ultrasonic impetus applied along with torque by driver 646, and/or gravity (in some but not all embodiment orientations) and constantly presented against electrode 650 by one or more helical conveyer features 631 on conveyer/compactor 630 to receive oxygen ions transported from passageways 648 across suitable ion transport membrane 652 (e.g., stabilized zirconia or other suitable ceramics).

In some embodiments conveyer screw 630 compacts the carbon particles sufficiently to make a carbon barrier or seal against the hydrogen produced by dissociation in the reactor section. In some embodiments conveyer 630 initially compacts the carbon particles by changing the pitch of helical features 631 and/or by reduction of the cross section including changing the shape of these features to compact and subsequently continuously deliver carbon particles to the surface against fuel cell electrode 650 for reaction with oxygen ions delivered through membrane 652. At the reaction interfaces 650 the compaction previously established to form a barrier against hydrogen may be relaxed to allow carbon dioxide to be easily expelled for travel along the helical passage ways to annular space 633 and accumulator 635 for transfer through conduit 637.

Such hot carbon dioxide can be reacted with surplus carbon or another carbon donor to produce carbon monoxide for various reactions and processes. In other suitable embodiments either oxide of carbon can be cooled by a countercurrent heat exchanger to preheat feed stock fuel and to facilitate reactions such as shown by Equations 7A-7C.

Hydrogen further pressurized by galvanic impetus is sealed by proton exchange membrane 641, which may be made of suitable materials including Perovskite type oxide ceramics such as doped barium cerate oxides or various composites including nano-tubes and/or graphene and/or ceramic such as various spinels and oxynitrides.

Conveyer 630 thus serves as a process accelerator and facilitator including performance as a rotary and/or ultrasonic harvesting system for carbon fuel particles that are deposited by the reactor 640-641-642, as a carbon particle compactor to block hydrogen travel from the reactor to the fuel cell 648-650-652 and as a carbon fuel presenter to fuel cell 648-650-652. Controller 625 adaptively adjusts the rotational speed of 646 and 630 along with the frequency and intensity of ultrasonic energy that can be applied separately and/or in addition to the energy generated by elements such as 617-619.

In some embodiments, air compressed by turbo-compressor 636-648 is delivered to membrane 648 to provide the portion of oxygen that is used by carbon-oxygen fuel cell portion of assembly 664 and the adaptively adjusted remaining portion of the nitrogen enriched air can be supplied to engine 662. In some embodiments, this efficiently accomplishes depression of the peak combustion temperature compared to exhaust gas recirculation and avoids the energy loss and difficult heat exchanger requirements to cool exhaust gases before such use.

Exhaust gas thermal energy that is wasted by expensive conventional exhaust recirculation systems is efficiently used by present embodiments to provide H2 for dissociation and improvement of energy yields of hydrogen and carbon derived from feed stock fuel compounds. Such nitrogen-enriched air can be adaptively mixed with air in conduit 609 from turbocharger 648 by valve 607 and supplied through conduit 632 for operation of engine 662 to reduce or eliminate production of emissions such as nitrogen monoxide.

The case of assembly 611 insulates and contains pressurized hydrogen that is collected and delivered to engine 662 through conduit 672 and manifold 622-627 to injectors 620. Accumulator 626 stores hydrogen for delivery through valve 625 at cold engine startup and/or to provide hydrogen to cool selected components and subassemblies such as hydraulic, pneumatic, magnetostrictive, piezoelectric, or solenoid actuators. Carbon dioxide produced by fuel cell 648-650-652 according to Equation 6 is delivered by helical passageways 631 in rotary conveyer 630 to annular passageway 633 to accumulator 635 for delivery through conduit 637 to various applications.

O₂+C→CO₂+Electricity Equation 6

Carbon dioxide taken from the atmosphere or more concentrated sources such as a bakery, brewery, calciner, power plant using carbonaceous fuel or fuel cell 648-650-652, by delivery through helical spaces 631 to collector 633 and accumulator 635 to conduit 637 which is virtually 100% carbon dioxide can be used to produce net hydrogen fuels such as a fuel alcohol as shown by representative Equation 7A.

CO₂+3H₂→CH₃OH+H₂O Equation 7A

Another embodiment provides reaction of a carbon donor “C” such as farm wastes, forest slash, sewage or garbage with carbon dioxide collected from the atmosphere or more concentrated sources to produce carbon monoxide as summarized in Equations 7B and production of a fuel such as methanol as shown by Equation 7C.

“C”+CO₂+HEAT₇→2CO Equation 7B

CO+2H₂→CH₃OH Equation 7C

This enables advantageous conversion of surplus, off-peak, spin-down, or regenerative energy into storable chemical fuel potential energy. A system embodiment with a carbon fueled fuel cell and a High Speed Hydrogen engine that uses the products of Equations 7A and/or 7C to serve as a solvent vehicle for carbon and/or hydrogen donor extracts (dC) from food wastes, agricultural animal and crop wastes, and solid municipal wastes accomplishes the process shown in Equation 8A.

CH₃OH+H₂O+dC HEAT₈→2CO+3H₂ Equation 8A

In operation the products of Equations 7A, 7C or 8A are separated into hydrogen, which may be galvanically pressurized and the carbon monoxide is used as a J-T expansive cooling fluid before TDC and hydrogen is injected at or after TDC to assure rapid initiation and completion of all fuel values and improved air-utilization efficiency. In the alternative portions of the carbon monoxide and hydrogen produced by Equations 4 and 8A are combined as shown in Equation 9 to produce liquid fuels such as formic acid, fuel alcohols (illustratively ethanol) and other compounds that may be selected for energy storage and to facilitate convenient net hydrogen fuel applications.

2CO+4H₂→C₂H₅OH+H₂O Equation 9

Another embodiment reacts hot carbon from Equation 4 with hot steam to produce carbon monoxide as shown in Equation 10. Such steam may be produced by heating water by H1, H2, and/or H3 additions in a heat exchanger such as 624 and/or 628.

H₂O+C+HEAT₁₀→CO+H₂ Equation 10

Carbon monoxide can be used in the fuel cell of system 664 or another suitable fuel cell to produce electricity and/or as a fuel such as a JT expansion cooling of fuel that is injected before TDC to reduce the work of compression after which hydrogen is injected to provide High Speed Hydrogen Combustion at propagation rates that exceed the speed of sound in carbon monoxide, air, or products of combustion such as carbon dioxide or water vapor.

Additional information pertaining to the disclosed technology is described in the attached document of Appendix A, which is included as part of this disclosure in this patent document.

While this patent document and attached appendix contain many specifics, these should not be construed as limitations on the scope of any disclosed methods or of what may be claimed, but rather as descriptions of features that may be specific to particular embodiments of particular disclosed methods. Certain features that are described in this patent document and attached appendix in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document and attached appendix should not be understood as requiring such separation in all embodiments.

Only a few implementations and examples are described and other implementations, enhancements and variations can be made based on what is described and illustrated in this patent document and attached appendix.

What is claimed are techniques and structures described and shown, including:

1. A system for converting a feedstock into a specialized carbon fuel for energy conversion, comprising:
a reactor to receive a feedstock substance and dissociate the feedstock substance to carbon constituents and hydrogen by applying one or both of heat and electric current, the carbon constituents including hot carbon having a temperature state in a range of 700° C. to 1500° C. and having an increased chemical potential energy capable of storing external energy; and
a fuel cell structured to include a chamber to receive the hot carbon, the fuel cell operable to receive and use the hot carbon as a fuel and air as an oxidant to (i) produce one or more oxides of carbon and one or more nitrogenous substances, or (ii) extract electrical energy from the hot carbon.

2. The system of claim 1, wherein the reactor is structured to include one or more electrodes to apply an electrical potential that provides the electric current or generates the heat to dissociate the fuel.

3. The system of claim 2, wherein the electrodes are formed of a material including at least one of a metallic alloy, graphite, silicon carbide, or molybdenum disilicide.

4. The system of claim 1, further comprising:
an engine structured to include a reaction chamber to receive the hot carbon,
wherein the reaction chamber facilitates a chemical reaction of the hot carbon with an oxygen- and hydrogen-containing reactant to produce a carbon oxide and additional hydrogen,
wherein the engine is operable to utilize one or both of the produced carbon oxide and additional hydrogen as fuel or as reactants in reactions within the engine.

5. The system of claim 4, wherein the oxygen- and hydrogen-containing reactant includes at least one of steam, alcohol, or air.

6. The system of claim 4, wherein the fuel cell is operable to receive and utilize one or both of the produced carbon oxide and additional hydrogen as fuel or as reactants in reactions within the fuel cell to extract electrical energy to produce electricity.

7. The system of claim 1, wherein the one or more oxides of carbon produced by the fuel cell include at least one of carbon monoxide or carbon dioxide, and the one or more nitrogenous substances produced by the fuel cell include at least one of ammonia or urea.
